(19) United States
(12) Patent Application Publication
(10) Pub. No.: US 2026/0234077 A1
(43) Pub. Date: Aug. 13, 2026

(54) SHELF STABLE ORGANIC FERTILIZER AND RELATED METHOD OF MANUFACTURE

(71) Applicant: Samuel Baker, Lake Mary, FL (US)

(72) Inventor: Samuel Baker, Lake Mary, FL (US)

(21) Appl. No.: 19/530,663

(22) Filed: Feb. 5, 2026

Related U.S. Application Data
(60) Provisional application No. 63/755,891, filed on Feb. 7, 2025.

(51) Int. Cl. C05F 17/05; B65B 25/02; B65B 31/04; C05F 17/30; C05F 17/40; C05F 17/80; C05G 5/23

(52) U.S. Cl. CPC C05F 17/05; B65B 25/02; B65B 31/046; C05F 17/30; C05F 17/40; C05F 17/80; C05G 5/23

(57) ABSTRACT

A method of creating shelf stable organic fertilizer includes obtaining a plurality of composting worms and supplying a food source to the worms to produce castings. The castings are dried and positioned within a porous membrane bag that is submerged into a water tank. Nutrients from the castings flows through the membrane bag and into the water to create a leachate. The leachate is extracted and purified to remove any remaining solid particulates. The leachate is then sterilized to kill the living microbes and spores of dormant beneficial microbes are added to the leachate. The leachate is then sealed within an airtight packaging. The resulting product is a shelf stable organic fertilizer having dormant microbes that reactivate when the packaging is ultimately opened and exposed to air.

### CROSS-REFERENCE TO RELATED APPLICATIONS

This application claims the benefit of U.S. Application Serial Number 63/755,891 filed on February 7, 2025, the contents of which are incorporated herein by reference.

### TECHNICAL FIELD

The following disclosure relates generally to the fertilizer industry, and more particularly to a shelf stable organic fertilizer and related methods of making the same.

### BACKGROUND

The statements in this section merely provide background information related to the present disclosure and may not constitute prior art.

Organic fertilizers, such as worm tea (also known as vermicompost tea), are renowned for their ability to improve soil health in a natural and sustainable way. Unlike traditional synthetic fertilizers which utilize isolated chemical nutrients that ultimately contribute to soil degradation and water pollution, organic fertilizers function differently by enriching the entire soil ecosystem. For example, worm tea contains beneficial microorganisms, enzymes, and organic compounds that help break down nutrients in the soil, making the nutrients more readily available to plants. This leads to healthier root systems and improved resistance to stress and disease.

Although incredibly useful for these reasons, organic fertilizers, and worm tea in particular suffer from one major drawback- shelf stability. Because these are living products that contain active microorganisms, worm tea must be used between 1 and 3 days after it is produced, or the microbes will die. When the microbes die and remain within the fertilizer, they begin to rot and spoil, which causes the fertilizer to lose its effectiveness and benefits. Although methods such as aeration and temperature control can extend the lifespan of the fertilizer by as much as 1 additional day, this remains the current limit of time for which worm tea can be stored. Unfortunately, the requirement that the worm tea must be brewed, sold, and used within a 2–4-day period of time severely limits the commercial viability of the product.

Accordingly, it would be beneficial to provide a shelf stable organic fertilizer and a related method of manufacturing the same so as to overcome the drawbacks noted above.

### SUMMARY OF THE INVENTION

The present invention is directed a method of creating shelf stable organic fertilizer.

In one embodiment, the inventive method can include obtaining a plurality of composting worms and supplying a food source to the worms to produce castings.

In one embodiment, the castings can be dried and positioned within a porous membrane bag that is submerged into a water tank. The nutrients from the castings can flow through the membrane bag and into the water to create a leachate. The leachate can then be extracted and purified to remove any remaining solid particulates.

In one embodiment, the leachate can undergo a sterilization process to kill the living microbes within the leachate. In one embodiment, the sterilized leachate can receive spores of dormant beneficial microbes before being sealed within an airtight packaging. The resulting product results in a shelf stable organic fertilizer having dormant microbes that reactivate when the packaging is ultimately opened and exposed to air.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a process flowchart for preparing a shelf stable organic fertilizer product according to a current embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein the term “shelf stable” and derivations thereof refer to the ability of a product to remain unused within its sealed packaging material for a period of at least 3 months, and up to about 36 months without deteriorating or otherwise losing its effectiveness.

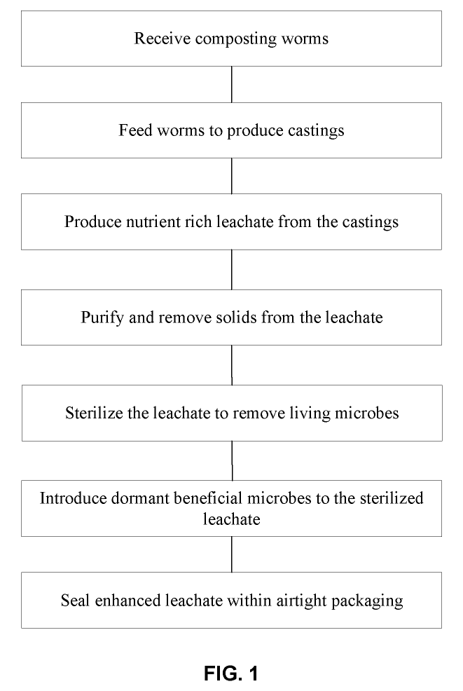

As described below, one embodiment of the inventive concept relates to a process that involves a worm farming system, nutrient extraction, purification, sterilization, and microbial or nutrient fortification to produce a shelf stable liquid biofertilizer suitable for long-term storage. More specifically, one embodiment of a method for producing shelf stable organic fertilizer can include the following steps, which are generally illustrated in the flowchart of FIG. 1. Other features of the current embodiments will become apparent in the course of the following descriptions, which are given for illustration of the current embodiments, and are not intended to be limiting thereof.

Step 1. Worm Casting Production. In one embodiment, the primary raw material for the creation of the inventive organic fertilizer can be worm castings (e.g., worm manure). Although many different types of worms may be utilized, it is preferred that composting worms selected from the following groups be utilized: Eisenia fetida / Eisenia Andrei, Eisenia hortensis / Dendrobaena veneta, Eudrilus eugeniae, and Perionyx excavatus.

In one embodiment, a specialized vertical worm farming system having a plurality of modular, stackable pallet-based worm beds designed for efficient space utilization and controlled decomposition of organic biomass can be utilized.

In this regard, the worms can be positioned within a bed such as a pallet or similar support structure that is lined with shade cloth, geotextile fabric, or another semi-permeable membrane to allow airflow while preventing material loss. The bed can be filled with manure, compost, agricultural byproducts, food waste, or other chemically organic matter suitable for vermicomposting, and the top of each bed can be covered with a breathable but insect-proof membrane to regulate moisture and gas exchange.

Once positioned within the beds, the worms can feed on various items to produce the desired castings. Although organic matter such as various fruits, vegetables, meats, and other such items can be used as the primary food source, one innovative and unique food source for use by the presently described method can include, comprise or consist of one or more pucks of Biogel.

As described in copending U.S. Patent Application No. 19/529,678 to Baker, the contents of which are incorporated herein by reference, Biogel is a biodegradable and plastic-free composition that is created by an innovative method that breaks down plastic, and turns it into a useful and environmentally friendly food source product. As such, the utilization of Biogel pucks as the food source in the worm casting step of the present method, advantageously provide metered and uniform feeding (with known mass, geometry, composition), potential improved bed hygiene and moisture control, along with enhanced biological safety, slower sustained nutrient release, improved traceability and monitoring, compatibility with a continuous or automated system, and the valorization of previously unrecyclable plastics or other materials.

In either instance, once the worms have digested the food source, the organic matter within the bed can be fully processed into worm castings. In one embodiment, the entire bed can be retrieved and emptied into a rotary trommel, vibratory screener, air separator, or similar screening device to separate worms from castings. Once separated, the worms can be returned to fresh beds for continuous production, and the castings can proceed to step 2.

The resulting castings produced by this step will have a generally granular composition similar to soil or used coffee grounds.

Step 2. Nutrient Extraction from Castings. In this step, the worm castings can be processed to extract their soluble nutrients in order to create a highly bioavailable leachate solution.

In the preferred embodiment, a membrane immersion technique is utilized wherein the earthworm castings are air dried and are then placed inside permeable membrane bags (e.g., nylon, woven polymer, or fabric filters) each having a plurality of holes about 70 microns in size. The bags and castings can then be submerged in large tanks of water, and can receive mechanical stirring, and aeration. The bubbles from the aeration and the flow of water function to break up the worm castings and allow the nutrients within the castings to enter the water, thus forming a leachate for use in the following method step.

Although described above as utilizing an immersion technique with specific types of bags and specific sized holes, other materials and sizes are also contemplated. Moreover, any number of other methods and systems to extract the nutrients from the castings such as utilizing a pressurized cartridge extraction and/or slurry separation via mechanical pressing are also contemplated.

The liquid leachate solution produced by this step will have a dark color with a plurality of particulates suspended within the fluid and living microbes.

Step 3. Purification & Particulate Removal. The leachate from step 2 can now be filtered to remove any remaining solid particulates. In the preferred embodiment, a centrifugal filtration system can be utilized; however, any number of other types of filtration systems such as gravity filters and/or membrane filters may also be used.

The purified liquid leachate solution produced by this step will have a generally clear color with living microbes, and no visible suspended particulates.

Step 4. Sterilization & Stabilization. The purified leachate from step 3 can now undergo sterilization to prevent microbial contamination and spoilage.

In the preferred embodiment, the purified leachate can undergo sterilization by being passed through a UV sterilization tube. As the leachate passes through the tube, it is exposed to ultraviolet light, heat, and ozone, which inactivate between 99.0% and 99.999% of the microbes present in the liquid, thereby rendering the leachate substantially sterile without otherwise degrading or removing the organic nutrients derived from the earthworm castings. By actively sterilizing the leachate at this stage, ongoing biological activity within the liquid is halted, preventing further microbial metabolism, replication, enzymatic degradation, and the formation of spoilage byproducts such as gases, odors, or precipitates. In contrast to allowing microbes to die naturally over time, which can result in uncontrolled cell lysis, secondary microbial growth, and continued nutrient consumption, the sterilization step stabilizes the leachate in a non-living state. As such, by removing viable microorganisms and suppressing biological activity, the resulting sterilized leachate resists spoilage and is capable of being stored for prolonged periods of time while retaining its intended effectiveness.

Although described above as utilizing UV radiation with heat and ozone, other sterilization methodologies are also contemplated. Several exemplary methods include but are not limited to: X-Ray or Gamma radiation, high-shear processing, and/or H₂O₂ deactivation, for example.

At the conclusion of this step, the purified and sterilized leachate will comprise a generally clear color having no visible suspended particulates, and no living microbes.

Step 5. Fortification for future activation. Once sterilized, the leachate from step 4 can undergo nutrient and dormant microbial fortification to ensure a microbial biome will sprout in the final use but will remain dormant during storage and transportation.

In one embodiment, spores of dormant beneficial microbes such as dehydrated spores of spore-forming bacteria of the genus Bacillus (for example, Bacillus subtilis, Bacillus amyloliquefaciens, Bacillus licheniformis, Bacillus pumilus, and Bacillus megaterium), dormant fungal spores (for example, Trichoderma species, Aspergillus species, and mycorrhizal fungi), and/or other dormant or metabolically inactive microorganisms may be added to the sterilized leachate received from step 4 immediately prior to packaging.

In some embodiments, powdered chitin or other microbial stimulants may additionally be included. The spores of dormant microbes introduced by this step remain in a metabolically inactive state within the sealed and airtight packaging of the leachate. As such, regardless of the duration of storage prior to use, the dormant microbes do not reactivate, reproduce, or undergo metabolic decay, and therefore do not consume nutrients or generate spoilage byproducts during storage. Upon dilution, soil application, or exposure to favorable environmental conditions, the dormant microbes can reactivate to establish the desired beneficial microbial biome at the point of use.

Thus, when the product packaging is ultimately opened and exposed to air, the microbes will reactivate from their dormant state to provide a culture of beneficial microbes within the leachate as it is applied to crops, plants, or soil. Moreover, because of the prior sterilization at step 4, the microbiome is now fully controlled, and the final user can be assured that the product now contains only the desired microbes as added by this step.

At the conclusion of this step, the fortified leachate will comprise a generally clear color having no visible suspended particulates, and dormant beneficial microbes.

Step 6. Packaging & Storage. In this step, the fortified leachate from step 5 can be packaged and vacuum sealed in an airtight container such as plastic or glass, for example. Once sealed, the shelf stable product can be stored and shipped to any desired location for use at any desired time.

At the conclusion of this step, the shelf stable product within the sealed container will comprise a leachate having a generally clear color with no visible suspended particulates, and dormant beneficial microbes.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state "means" for performing a specified function or "step" for performing a specified function should not be interpreted as a "means" or "step" clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of creating shelf stable organic fertilizer, said method comprising:
obtaining a plurality of worms;
producing castings from the obtained worms;
producing a leachate from the castings;
sterilizing the leachate; and
packaging the sterilized leachate,
wherein the sterilized leachate includes a stable shelf life of at least 1 year.

2. The method of claim 1, wherein the plurality of worms comprise:
composting worms.

3. The method of claim 2, wherein each of the composting worms are selected from a group of Eisenia fetida, Eisenia Andrei, Eisenia hortensis, Dendrobaena veneta, Eudrilus eugeniae, and Perionyx excavatus.

4. The method of claim 1, wherein said producing a leachate is achieved via a membrane immersion technique.

5. The method of claim 4, wherein said membrane immersion technique includes:
drying the castings produced by the plurality of worms;
placing the castings into a permeable membrane bag;
submerging the membrane bag into a tank of water;
releasing the nutrients from the membrane bag into the water to form the leachate.

6. The method of claim 5, wherein the leachate includes a dark color with a plurality of suspended solid particulates and living microbes.

7. The method of claim 1, further comprising:
removing any solid particulates from the produced leachate.

8. The method of claim 7, wherein the solid particulates are removed via a centrifugal filtration system.

9. The method of claim 8, wherein the exiting the centrifugal filtration system includes a clear color with living microbes and no suspended solid particulates.

10. The method of claim 1, wherein said sterilizing the leachate is configured to kill any living microbes within the leachate.

11. The method of claim 10, wherein the leachate is sterilized by ultraviolet light.

12. The method of claim 1, wherein said packaging the sterilized leachate comprises:
positioning the sterilized leachate into an airtight container; and
vacuum sealing the airtight container.
